(19) United States
(12) Patent Application Publication
(10) Pub. No.: US 2002/0143660 A1
(43) Pub. Date: Oct. 3, 2002

(54) Method and system for online shopping

(75) Inventors: Maria Azua Himmel, Yorktown Heights, NY (US); Herman Rodriguez, Austin, TX (US); Newton James Smith JR., Austin, TX (US); Clifford Jay Spinac, Austin, TX (US)

Correspondence Address: Frank C. Nicholas, CARDINAL LAW GROUP, 1603 Orrington Avenue, Suite 2000, Evanston, IL, 60201, US

(73) Assignee: International Business Machines Corporation, Armonk, NY (US)

(21) Appl. No.: 09/820,505

(22) Filed: Mar. 29, 2001

(51) Int. Cl. G06F 17/60

(52) U.S. Cl. 705/27

(57) ABSTRACT

A system and method facilitating online shopping at different merchant sites is provided. A client-based shopping cart application generates an online shopping cart usable at plural merchant sites. The shopping cart application can be a browser plug-in running on a remote client computer. The client shopping cart application stores product and shopper configuration information locally on the client computer and allows the exchange of information between merchant sites and the shopping client. The client shopping cart can contain items from different merchant sites. At check-out time, the shopping cart application seamlessly transfers information about the purchaser and the items in the shopping cart to the various merchant sites. The client shopping cart can be configured to limit various shopping attributes, such as the sites that can be visited, the amount that can be spent shopping, the time of day that shopping can take place, as well as language and currency limitations.

### TECHNICAL FIELD OF THE INVENTION

The invention relates generally to online shopping, and in particular, to an improved shopping cart application for facilitating online shopping.

### BACKGROUND OF THE INVENTION

Online shopping has become increasingly popular on the World Wide Web (“web”). There are currently thousands of merchant web sites offering products and services for sale. At many of these merchant web sites, virtual “shopping carts” are available customers. Generally, these so-called shopping carts are server-side software applications that permit customers, who are browsing a merchant site, to conveniently select and purchase items advertised at the site. Shopping cart software typically generates web pages presentable to shoppers, where the web pages show lists of items that the shoppers have selected for purchase. The web pages can also include user-selectable options for altering the selections and for automatically “checking out”, or purchasing the selected items in the shopping cart.

Although web-based shopping carts have been a boon to online shopping, their current implementation presents some limitations. One limitation is that available shopping cart applications are server based, meaning that the shopping carts they present are tied to a particular web site. Thus, under server-based implementations, an online shopper must create a different shopping cart for each merchant web site visited. A shopping cart cannot be easily “taken” from one merchant site to another, and therefore, a shopper may have to re-enter product and personal information each time he/she connects to a different merchant site.

Another limitation is that many shopping cart applications do not provide users with the ability to configure or personalized the shopping cart. The ability to personalize an online shopping cart would add to its convenience of use.

Accordingly, there is a need for an improved online shopping cart that allows customers to conveniently move among merchant web sites and to personally configure the features and manage the contents of the shopping cart.

### SUMMARY OF THE INVENTION

It is an advantage of the invention to provide an improved online shopping cart system and method that overcomes the limitations discussed above.

According to one embodiment of the invention, a client shopping cart application is provided. The client shopping cart can be a web browser plug-in that provides an online shopping cart usable at different merchant web sites. In this embodiment, the client shopping cart operates as follows. Upon connecting to a merchant site, the client shopping cart determines whether the site supports the client shopping cart. If so, information is exchanged between the merchant site and the client shopping cart regarding one or more items in the shopping cart and the configuration of the shopping cart itself. At check-out time, the client transfers check-out information for the items in the shopping cart from the client to the merchant sites.

According to another embodiment of the invention, a system for online shopping includes a remote client running a shopping cart application for generating an online shopping cart usable at a plurality of merchant sites. A browser application running on the remote client permits connections to the merchant sites. The shopping cart application exchanges configuration and product information between the merchant sites and the remote client. At check-out, the shopping cart application can transparently transfer purchase information contained in the shopping cart to the merchant sites.

### BRIEF DESCRIPTION OF THE DRAWINGS

FIG. 1 is a diagram illustrating an online shopping system in accordance with the present invention;

FIG. 2 is a flow chart illustrating operation of the shopping cart application shown in FIG. 1; and

FIG. 3 is a flow chart illustrating a method using the shopping cart application of FIG. 1 to create an online shopping cart.

### DETAILED DESCRIPTION OF THE PRESENTLY PREFERRED EMBODIMENTS

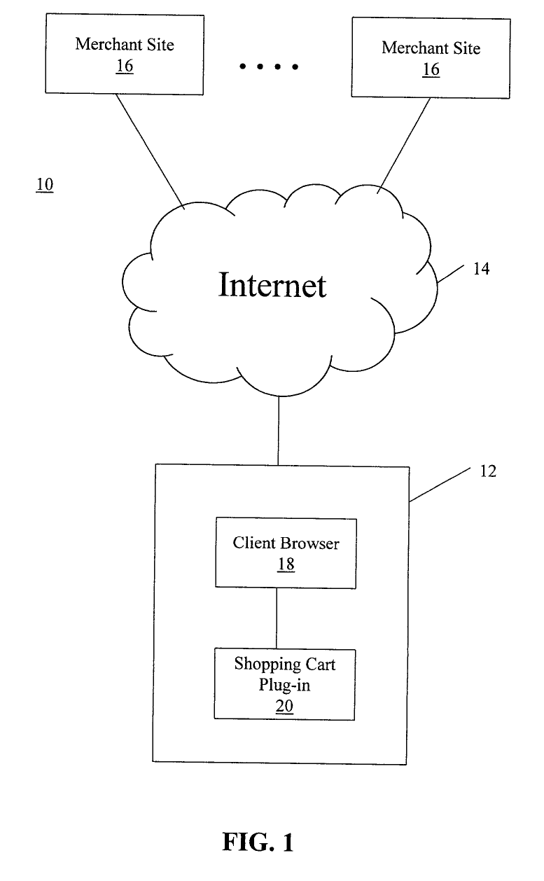

Turning now to the drawings, and in particular to FIG. 1, there is illustrated an exemplary online shopping system 10 in accordance with one embodiment of the present invention. The online system 10 includes a remote client 12 communicating with a plurality of merchant sites 16 by way of a computer network 14, such as the Internet. The merchant sites 16 can be websites for offering goods and services for sale. The merchant sites can be built using commercially-available server hardware and web server software configured to support the online shopping cart described herein.

The remote client 12 can be a web-enabled device, such as a personal computer, personal digital assistant, cellular telephone, pager, or the like.

The remote 12 includes a client browser 18 and a shopping cart plug-in 20. The client browser 18 can be any software application suitable for accessing websites over the internet, such as the Internet Explorer, available from Microsoft Corporation.

Although shown in FIG. 1 as a software plug-in, the client shopping cart disclosed herein can be implemented in any suitable form, such as an application program, firmware, or as a custom application specific integrated circuit.

The client shopping cart plug-in 20 is a software application providing an online shopping cart usable at the merchant sites 16. The client shopping cart can contain items from different merchant sites. The client shopping cart plug-in 20 provides advantage in that it permits a user to shop across multiple websites, and also allows check-out to be accomplished in a single step. Another advantage of the shopping cart plug-in 20 is that it permits the contents of the cart to be visible to the various merchants on the web. For example, in situations where the shopper selects an item at one merchant, and later visits another merchant, the latter merchant could see the selected item in the cart, and could offer a better price or product selection. This provides an opportunity for web merchants to “bid” better prices.

Another scenario is that merchants can offer discounts when they detect items in a shopping cart that were selected from other websites having a preferred relationship with the current website or offering related items or services. For example, if a shopper has placed a travel package to Cancun in a shopping cart, and then visits a scuba diving website, the shopper could be provided with a 5% discount on purchases at the scuba diving site because the scuba diving web site was able to see the travel package to Cancun.

A further advantage of the shopping cart plug-in 20 is that it is easier to use because it can be configured only once to store user information and the same information can be used on every merchant site 16.

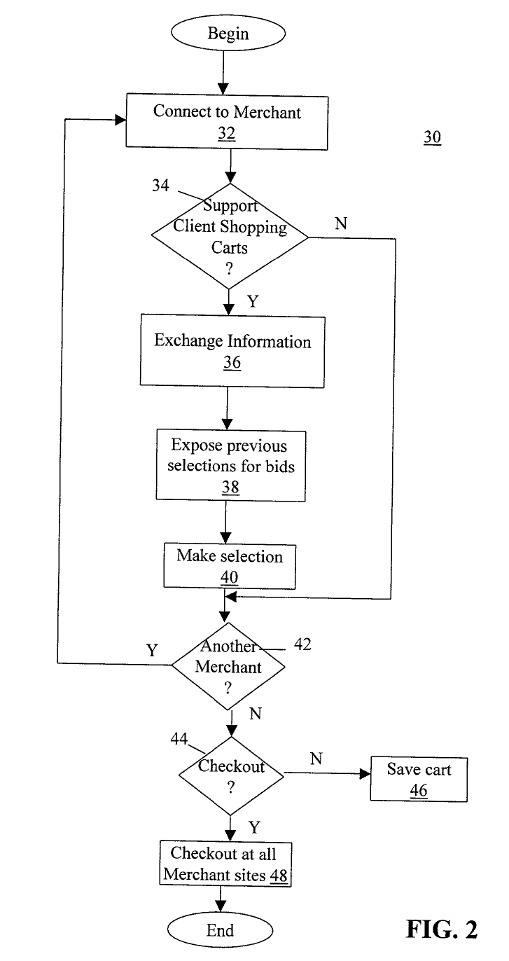

FIG. 2 is a flow chart 30 illustrating operation of the shopping cart application 20 shown in FIG. 1. In step 32, the browser 18 connects to one of the merchant websites 16. The browser 18 can connect to the site and exchange information using the hypertext transfer protocol (HTTP) or any other suitable protocol. In decision step 34, a check is made to determine whether the merchant site supports the client shopping cart plug-in 20. If not, the shopper is notified by the browser 18, and may select another merchant (step 42).

If the merchant site indicates to the remote client 12 that it supports the shopping cart plug-in 20, shopping cart information is exchanged between the remote client 12 and the merchant site 16 (step 36).

Although the invention is not so limited, the client 12 running the shopping cart plug-in 20 can provide a merchant web server with the following shopping cart data: the user-selected name of the shopping cart, a description of each item in the shopping cart, the uniform resource locators (URLs) of the sites that conduct the check-out for the items in the shopping cart, and an indicator of whether of not each item in the shopping cart is to be included during check-out.

The user-selected name of the shopping cart can be correlated to its use. For instance, a user can have a “family” shopping cart, as well as a separate “business” shopping cart. The business shopping cart could be customized in the shopping cart plug-in to keep track of tax deductible items purchased during the year.

In step 38, information about previous item selections, i.e., items currently in the shopping cart, can be exposed to the merchant website to solicit competitive bids from the merchant. This involves the transfer of item information from the shopping cart plug-in 20 to the merchant site 16. The merchant site 16 can be configured to compare product information in the shopping cart to that available from the merchant. If similar items are detected, the merchant site can automatically notify the shopper, by way of the browser 18, that it can offer the same items in the shopping cart at a better or discounted price.

If a user does not want items in the shopping cart to be exposed to other merchant web sites, the user can selectively “hide” the items in the cart. A web page can be generated by the plug-in for allowing the user to hide items. These hidden items are not visible to other web sites, except the one where they were originally selected. Although these items are not visible to other sites, they can nevertheless be purchased or discarded from the cart at check-out time.

In step 40, the shopper makes selections, such as selecting items for purchase from the merchant site or replacing items in the cart with those competitively bid by the merchant site. While shopping at the merchant website, when a user places an item in the shopping cart, the merchant server 16 sends the client shopping cart 20 the following information: a complete description of the item, the quantity of items selected, the cost of each item, the shipping cost of each item, an expiration date for the price guaranteed for each item, and identification of the information fields required to be submitted when checking out.

The check-out information fields can include items such as the shopper name, shipping address, shipping instructions, payment information, email address which confirmations are sent and the like.

The user can view the contents of the shopping cart at any time and delete individual or all of the items in the cart.

In addition to storing item and shopper information, the shopping cart plug-in can store electronic coupons and award points at the remote client 12, for redemption at check out or some later time.

In step 42, a check is made to determine whether another merchant site 16 has been selected. If so, the process returns to step 32, where a connection is made to the new merchant site. If another merchant is not selected, the shopping cart plug-in 20 can proceed to check-out (step 44) or the shopping cart can be stored.

If check-out is selected by the shopper, the shopping cart plug-in sends the product information to the various merchant sites 16 in an automatic manner (step 48). The shopping cart plug-in contacts each merchant site, via the URLs specified in the shopping cart, with a list of items to be purchased at the respective sites and the check-out information, as required for each merchant site.

The shopper can select which items are to be checked out. Those that are not selected for purchase can remain in the shopping cart for a user-specified time, or until the price guaranteed by the merchant expires.

If check-out information is not available to the plug-in, a plug-in dialogue is presented to the user. The dialogue permits the user to manually enter any missing information. To accomplish manual entry, a single form with accumulative list of required items is presented to the user. The form can be an HTML (hypertext markup language) page displayable by the browser 18.

For example, the user needs to enter the shipping address only once, if it stored in the browser preferences for the shopping cart. This address is the one that will be use during client check-out. If the shipping address is already stored in the client shopping cart, then the menu does not need to request a shipping address from the shopper during check-out, but may request a confirmation.

After completing the check-out process, the merchant sites can send the remote client 12 one or more check-out status objects, which are stored by the client plug-in 20, for tracking the status of orders. To track an order, a user can access the corresponding check-out status object using the plug-in 20, which then sends a tracking request to the URL of a merchant site. In response, the merchant site returns an order status update.

If the shopper decides not to check-out or to do a partial checkout, the contents and configuration of the cart are saved (step 46). The shopping cart and shopper data are stored locally at the remote client 12.

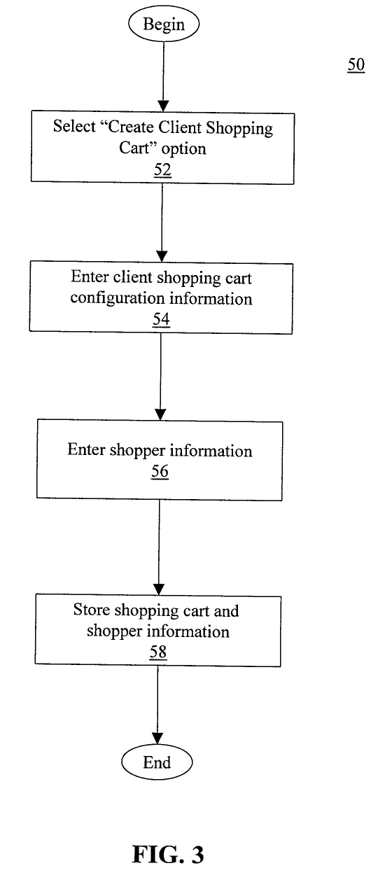

FIG. 3 is a flow chart 50 illustrating a method of using the shopping cart plug-in application of FIG. 1 to create an online shopping cart. In step 52, a user selects a “create shopping cart” option from a menu presented by the shopping cart plug-in 20 at the remote client 12. The menu can be presented by an HTML, Java, Java script, or any other suitable language for creating web pages. The menu option can present a series of forms that can be filled out and entered by the user in a step-by-step method. Using these forms, the user can enter shopping cart configuration information (step 54).

The configuration information includes a name for the shopping cart, a user ID and password for accessing the shopping cart, limitations on using the shopping cart, e.g., time of day limitations, spending limits, restrictions on merchant sites which can be visited, and the like. The time of day limitations can restrict when the shopping cart is used.

The length of time items are allowed to remain in the shopping cart can also be specified. A stored shopping cart will retain the items until the user-selected time limit expires. Also, items can be tagged with merchant selected expiration dates that guarantee a price for a certain time period. After the time period has expired, the items are automatically remove from the cart.

In addition, the user can set language and currency requirements, and can also require specific purchase approvals before check out can be completed. For example, a parent can create a shopping cart for a child and configure the shopping cart to require entry of a parent password before commencing the check-out process. Likewise, a boss can create an employee shopping cart with similar restrictions. In addition, the check out authorization can be specified for specific items.

Further, limits may be placed on what items are put in the shopping cart. For instance, a shopping cart can be configured so that alcoholic beverages can not be placed therein.

Also, the shopping cart can be configured to allow purchases on behalf of another person.

In step 56, the user can enter shopper information corresponding to the shopping cart. The shopper information can include a shipping address, credit card information, and any other information specific to the user(s) of the shopping cart.

In step 58, the shopping cart configuration information and shopper information is stored locally at the remote client 12. Alternatively, the information can be stored at a site on the web at a user-specified location. This information can be later retrieved by the shopping cart plug-in 20 while the user is visiting the various merchant sites 16 or checking out.

A user can create multiple shopping carts for different purposes. A shopping cart can be selected from a list of shopping carts using a pull-down menu on the browser 18, generated by the shopping cart plug-in 20.

The plug-in 20 can also support the transfer and combining of shopping carts. For example, a “family” shopping cart can be configured to include children's' shopping carts, and thus, receive items from the children's' shopping carts. Thus, a shopping cart can be place within another shopping cart. To transfer a shopping cart to another user, the plug-in generates a shopping cart object, which includes configuration and item information that can be sent to the user by way of email or some other suitable communications path. The recipient can either accept or decline the sent shopping cart.

The shopping cart plug-in 20 can be implemented in software using a standard programming language, such as Java™ or XML, and stored in a computer-usable medium, such as a CDROM, solid-state memory, DVD, floppy disk, hard disk, or the like.

While the embodiments of the present invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

What is claimed is:

1. A method of online shopping, comprising:
providing a client shopping cart application for generating an online shopping cart usable at a plurality of merchant sites;
connecting to a merchant site;
exchanging information between the merchant site and the client shopping cart regarding one or more items in the shopping cart; and
transferring check-out information for at least one of the items in the shopping cart from the client shopping cart to at least one of the merchant sites.

2. The method of claim 1, further comprising:
determining whether the merchant site supports the client shopping cart application.

3. The method of claim 1, further comprising:
exposing the items in the shopping cart for bids from the merchant sites.

4. The method of claim 1, further comprising:
selectively hiding information regarding at least one of the items.

5. The method of claim 1, further comprising:
password protecting the online shopping cart.

6. The method of claim 1, further comprising:
obtaining purchase approval prior to transferring check-out information.

7. The method of claim 1, further comprising:
configuring the shopping cart according to configuration information received from a user.

8. The method of claim 1, wherein the exchanged information includes one or more uniform resource locators (URLs) associated with the checkout of each of the items.

9. The method of claim 1, wherein the exchanged information includes an indication of whether the items are to be included during checkout.

10. The method of claim 1, further comprising:
retrieving locally stored shopper information for checkout; and
transferring the locally stored information to the at least one merchant site.

11. The method of claim 10, further comprising:
determining whether any of the stored shopper information is missing; and
prompting the shopper to manually enter missing information.

12. The method of claim 1, further comprising:
transferring a confirmation object from the at least one of the merchant sites to the client shopping cart application.

13. A computer program product stored in a computer-usable medium, comprising:
means for providing a client shopping cart application for generating an online shopping cart usable at a plurality of merchant sites;
means for connecting to a merchant site;
means for exchanging information between the merchant site and the client shopping cart regarding one or more items in the shopping cart; and
means for transferring check-out information for at least one of the items in the shopping cart from the client shopping cart to at least one of the merchant sites.

14. The computer program product of claim 13, further comprising:
means for determining whether the merchant site supports the client shopping cart application.

15. The computer program product of claim 13, further comprising:
means for selectively hiding information regarding at least one of the items.

16. The computer program product of claim 13, wherein the exchanged information includes one or more uniform resource locators (URLs) associated with the checkout of each of the items.

17. The computer program product of claim 13, wherein the exchanged information includes an indication of whether the items are to be included during checkout.

18. The computer program product of claim 13, further comprising:
means for retrieving locally stored shopper information for checkout; and
means for transferring the locally stored information to the at least one merchant site.

19. The computer program product of claim 18, further comprising:
means for determining whether any of the stored shopper information is missing; and
means for prompting the shopper to manually enter missing information.

20. The computer program product of claim 13, further comprising:
means for transferring a confirmation object from the at least one of the merchant sites to the client shopping cart application.

21. A system for online shopping at one or more merchant sites, comprising:
a remote client running a shopping cart application for generating an online shopping cart usable at a plurality of merchant sites;
a browser application running on the remote client for connecting to a merchant site;
means for exchanging information between the merchant site and the client shopping cart regarding one or more items in the shopping cart; and
means for transferring check-out information for at least one of the items in the shopping cart from the client shopping cart to at least one of the merchant sites.

22. The system of claim 21, further comprising:
means for determining whether the merchant site supports the client shopping cart application.

23. The system of claim 21, further comprising:
means for selectively hiding information regarding at least one of the items.

24. The system of claim 21, further comprising:
means for retrieving locally stored shopper information for checkout; and
means for transferring the locally stored information to the at least one merchant site.
